(19) United States
(12) Patent Application Publication
(10) Pub. No.: US 2010/0307821 A1
(43) Pub. Date: Dec. 9, 2010

(54) External Sleeve

(76) Inventor: Thilo Simonsohn, Munich (DE)

Correspondence Address: BARLEY SNYDER, LLC, 1000 WESTLAKES DRIVE, SUITE 275, BERWYN, PA, 19312, US

(21) Appl. No.: 12/845,426

(22) Filed: Jul. 28, 2010

Related U.S. Application Data
(63) Continuation of application No. PCT/EP2009/050830, filed on Jan. 26, 2009.

(30) Foreign Application Priority Data
Feb. 4, 2008 (DE) 10 2008 007 405

(51) Int. Cl. H02G 15/02

(52) U.S. Cl. 174/74 A

(57) ABSTRACT

An external sleeve joins two or more cable ends. The external sleeve includes a sleeve body, a shielding layer, an outer wall, and a barrier layer. The shielding layer is an electrically conducting shielding layer arranged along an outside of the sleeve body. The outer wall is arranged along the outside of the shielding layer. The barrier layer has a permeability factor, and is arranged along the inside of the outer wall. As a result, the penetration of fluids is reduced.

### CROSS-REFERENCE TO RELATED APPLICATIONS

This application is a continuation of PCT International Application No. PCT/EP2009/050830, filed Jan. 26, 2009, which claims priority under 35 U.S.C. §119 to German Patent Application No. 10 2008 007 405, filed Feb. 4, 2008.

### FIELD OF THE INVENTION

The present invention relates to an external sleeve, and in particular, to a an external sleeve for joining two or more cable ends.

### BACKGROUND

A ground cable is a power cable or telecommunications cable which is laid in the ground and provides external protection such as a sheath, which prevents the cable from being destroyed by chemical and mechanical influences in the ground by water or small animals such as rodents which live in the ground, or even by fungi.

To provide mechanical protection, ground cables are occasionally also laid in a layer of sand in the ground so that sharp-edged stones cannot damage the cable when the ground is stressed for example by vibrations of nearby rail or road traffic. Ground cables for voltages below 100 kV can be produced in a multi-polar configuration, while single-pole configurations such as single-conductor cables are used for higher voltages.

Today, cables which have a plastics material sheath are mainly used for voltages up to 200 kV, while cables having an insulation of oil-impregnated paper are also used for these and higher voltages. Presently, lines having voltages below 100 kV are configured in principle as ground cables in newly constructed residential or industrial areas. The power lines for supplying the houses in many older residential areas are also configured as ground cables. In general, ground cables are laid at a depth of 60 cm or 80 cm in a road area. Plastics material sheets are used in addition to warning tape to protect the cables from being punctured and exposed by digging.

Ground cables have some advantages compared to overhead lines. They are protected most effectively from damage, caused inter alia by adverse weather conditions such as storms, hail and lightning. In addition, their electromagnetic compatibility is better. However, such a design provides for higher costs in manufacturing.

A sleeve is a construction element for joining two or more cables in an interruption-free manner or for splitting a cable, for example when a branch of a power cable has to be guided to a house.

Depending on use, a distinction is made between coupling sleeves or straight-through joints and branch sleeves which occasionally also differ in their construction. Various known external sleeves types are, inter alia, cast resin sleeves, shrunk-on sleeves (heat and cold shrink sleeves) and sleeves in the slide-on method, various types of sleeve possibly being used in power engineering in various voltage planes, such as low voltage and medium voltage. In the low voltage range (<1000 V), heat shrink and cold shrink sleeves are used, while sleeves in the slide-on method as well as heat and cold shrink sleeves are used in the medium voltage range.

Different types of internal sleeves are shown in longitudinal section in FIGS. 16, 17 and 18. FIG. 16 shows a heat shrink internal sleeve, while FIG. 17 shows an internal sleeve for the slide-on method. FIG. 18 shows a cold shrink internal sleeve on a spiral.

FIGS. 19 to 22 show various external sleeves in longitudinal section. FIG. 19 shows a heat shrink external sleeve, while FIG. 20 shows a cold shrink external sleeve in which the tube is folded back, so that the parking length of the assembly is shorter. FIG. 21 shows a housing of a cast resin external sleeve and FIG. 22 shows that an external sleeve can also be applied in a winding method using a tape, i.e. an adhesive tape.

For maximum voltage cables, a prefabricated sleeve is used which is completely dry, i.e. it does not contain gaseous or fluid substances and does not require any maintenance. For this reason, the most important electrical parts can be pre-checked in the factory. This accelerates the on-site assembly and reduces the risks associated therewith.

The sleeve consists of two slip-on silicone field control elements, a filling band, thick-walled insulating tubes, an outer conductive combi-tube, a copper gauze shielding and a thick-walled shrunk-on tube as the outer protection.

Medium voltage cables, and thus single-conductor cables will be discussed for the most part in the following description. In this case, a fold-down outer tube is preferably applied to the sleeve body.

For medium voltage cables and lines insulated with plastics materials, there are external sleeves in the cold shrink, slip-on and heat shrink methods. Coupling sleeves are used when cables are laid in the ground, in cable shafts and under open air conditions. The cables can have firmly welded or graphitised outer conducting layers or outer conducting layers which can be stripped off

Protection against permeation is important for cables laid underground. Substantial impermeability to water vapor is preferred, since the copper gauze, the earth wires and the shielding wire connections are to be protected against corrosion, otherwise they lose their contactability. Moreover, the water absorption of the sleeve body, which is produced from sheets and thus absorbs considerable amounts of water, is to be reduced.

Today, the sleeve assembly is part of the routine work of laying medium voltage cables. A method is utilized to provide satisfactory application reliability and short assembly times.

The joining of the prime conductor and the shielding wires is prepared using screw connections and crimp connectors. Shearing screws having a definite torque and simplify this step. They ensure an excess-free tear-off for different conductor cross sections. The field control at the end of the cable shielding as well as via the connector is carried out, for example by means of geometric field control elements which are integrated into the one-piece sleeve in the domain of the medium voltage method. The insulation and external field boundary is undertaken by a sleeve body consisting of high-quality silicone rubber or EPDM rubber (ethylene propylene diene copolymer). A choice of a heat shrink tube or an elastomeric protective tube, a tube in the winding method or cast resin ensures the outer protection of the sleeve.

The conductor connection is produced with the screw connector. The sleeve body can then be pushed into its final position. The sleeve body can be easily positioned over the outer sheath of the cable. An adhesive-coated heat shrink tube or an elastomeric tube, for example, can be provided for the external protection of the sleeve.

An all-in-one (one-piece) cold shrink sleeve is constructed as follows: a supporting element or supporting spiral, for example a spiral hold-out, holds the diameter of the expanded sleeve body. In order to facilitate the installation process and to make it reliable, a copper gauze tube or stocking is used to join the shielding wires, which tube or stocking is to be previously applied onto the expanded body, the preferably tin-plated copper wires having a minimum cross section.

The EPDM of the protective tube has a finite water vapor permeability which, in the case of cables laid underground, can result in corrosion damage to the metal and water absorption by the sleeve body. Water is able to penetrate through the rubber material of the outer tube (permeation) or through a leaky connection between the rubber tube and the outer sheath of the cable. A mastic (sealing rubber/sealing compound) is almost always used on the outer sheath. This is very tacky and, through the contact pressure, increases the diameter of the cable.

Underground cables and sleeves are exposed to a considerable amount of pressure. This pressure is exerted in the form of stones, sharp edges and vibrations on the outer skin, formed from soft rubber, of the cold shrink sleeve, whose wall thickness is reduced thereby. Microbes are a further source of risk. Many sleeves have been laid which have a defective outer tube, which may go unnoticed in day-to-day use. This can result, for example in the metallic wires in the sleeve corroding and in the contacts becoming impaired. However, the use of all-in-one sleeves is still desired, as the above-described advantages of these sleeves will be retained.

### SUMMARY

In view of these drawbacks, it is an object of the invention, among other objects, to reduce the access of fluid to the sleeve body or to the point where the shielding wires join one another, in particular if this joining point is realised by a scroll spring.

An external sleeve is provided for joining two or more cable ends. The external sleeve has a sleeve body, an electrically conducting shielding layer, an outer wall and a barrier layer. The electrically conducting shielding layer is arranged along an outside of the sleeve body. The outer wall is arranged along the outside of the shielding layer and the barrier layer has a permeability factor while being arranged along the inside of the outer wall.

### BRIEF DESCRIPTION OF THE DRAWINGS

The invention is described in more detail in the following with reference to the embodiments shown in the drawings. Similar or corresponding details in the Figures are provided with the same reference numerals. The invention will be described in detail with reference to the following figures of which:

FIG. 1 is a cross sectional view of an external sleeve according to the invention;

FIG. 2 is a longitudinal sectional view of the external sleeve according to the invention;

FIG. 3 is a perspective view of the external sleeve according to the invention with a reduced-water-permeability layer;

FIG. 4 is a perspective view of one embodiment of the external sleeve according to the invention;

FIG. 5 are sectional views of several embodiments of the external sleeve according to the invention;

FIG. 6 is a sectional view of a further embodiment of the external sleeve according to the invention;

FIG. 7 is a sectional view of a further embodiment of the external sleeve according to the invention;

FIG. 8 is a sectional view of a further embodiment of the external sleeve according to the invention;

FIG. 9 is a sectional view of a further embodiment of the external sleeve according to the invention;

FIG. 10 is a perspective view of a further embodiment of the external sleeve according to the invention;

FIG. 11 is a perspective view of a further embodiment of the external sleeve according to the invention;

FIG. 12 is a graphical representation charting water vapour permeability as a function of the foil thickness;

FIG. 13 is a table of oxygen and water vapour barrier values of current plastics materials;

FIG. 14 is a graphical representation charting oxygen and water vapour permeability of selected polymers;

FIG. 15 is a graphical representation charting temperature dependency of a diffusion coefficient;

FIG. 16 is a sectional view of a known heat shrink internal sleeve;

FIG. 17 is a sectional view of a known internal sleeve in the slip-on method;

FIG. 18 is a sectional view of a known internal sleeve in the cold shrink method on a spiral;

FIG. 19 is a sectional view of a known heat shrink external sleeve;

FIG. 20 is a sectional view of a known cold shrink external sleeve with a folded-back tube;

FIG. 21 is a sectional view of a known external sleeve in the cast resin method with a housing;

FIG. 22 is a sectional view of a known external sleeve in the winding method with tape;

FIG. 23 is perspective view of a known foil tube for use with all types of external sleeves;

FIG. 24 is a sectional view of a known thick-walled tube with a thin-walled foil pre-expanded on a spiral hold-out; and

FIG. 25 is a sectional view of a known thick-walled reduced-permeation tube with an integrated copper gauze pre-expanded on a spiral hold-out.

### DETAILED DESCRIPTION OF THE EMBODIMENT(S)

The present invention is described with respect to a cold shrink all-in-one sleeve for medium voltage cables, although the application is not restricted to this case. The invention could be used just as well in the low or high voltage ranges, as well as for heat shrink methods and for the slip-on method. The external sleeves can be connections of power cables as well as telecommunication cables.

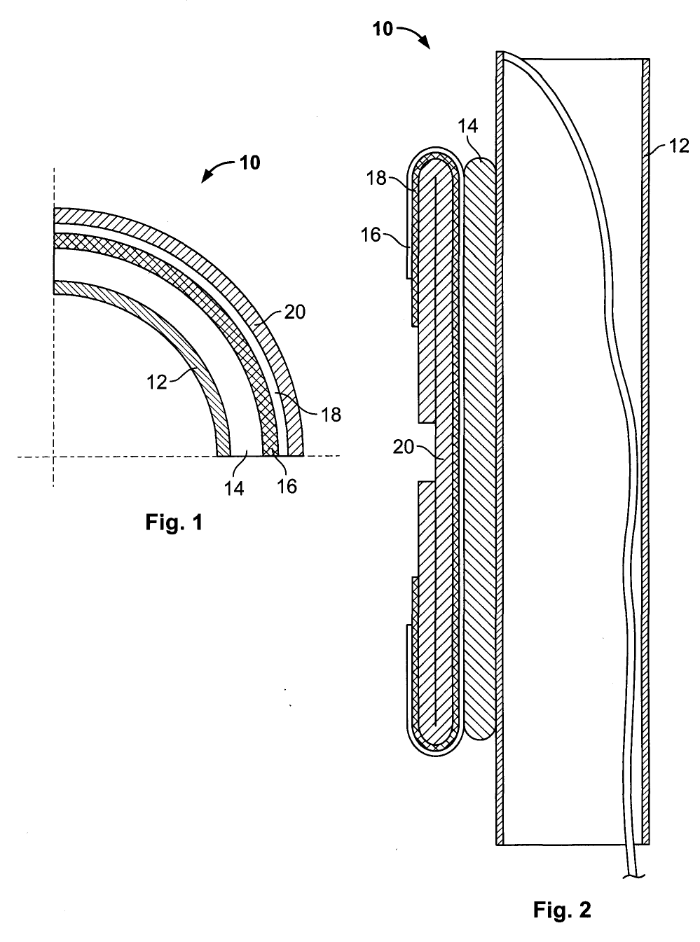

FIG. 1 shows a cross section of a sleeve 10, which clarifies the construction of the sleeve 10. In the very centre is a supporting element 12, which is surrounded by a sleeve body 14. Positioned over the sleeve body 14 is an electrical shielding 16, for example a copper gauze, which in turn is surrounded by a barrier layer 18, for example a permeation protection foil. The outer wall 20 surrounds this construction.

The supporting element 12 supports the further layers i.e. sleeve body 14, electrical shielding 16, barrier layer 18 and outer wall 20, of the sleeve 10 in the expanded state. This supporting element 12 is configured as a spiral hold-out or supporting spiral, but can also consist of other principles, in particular two parts of a supporting tube which can be pulled apart. The supporting element 12 only supports the sleeve 10 in the delivery state, because said supporting element 12 is removed as soon as the ends of the cable have been joined.

The sleeve body 14 consisting of elastomer (for example silicone or EPDM) which insulates the conductor of the single-conductor cable is also part of the prefabricated sleeve 10. The sleeve body 14 also provides for the field control and supports the outer conducting layer. The thickness and configuration of the sleeve body 14 depends on the specification of the cables to be joined.

To join the shielding wires of the cable ends, an electrical shielding 16 is provided, for example a copper gauze tube or stocking integral with the construction of the sleeve 10. The electrical shielding 16 is fitted around the sleeve body 14. The copper wires, which are tin plated in the embodiment shown, have an overall minimum cross section. This could be a matter of a copper wire with a large cross section, or for example forty copper wires with a small cross section, as the total of all the cross sections is used for this purpose. For joining the shielding wires, tin-plated copper wires of a maximum diameter of 3 mm, preferably from 0.5 to 1.5 mm are used, or commercially available wire braid (diameter reduced according to the number) is used.

The outer wall 20, also called an external sleeve 10, is more often than not produced from EPDM rubber (ethylene-propylene-diene rubber) for use in the cold shrink method. EPDM rubber is a terpolymer elastomer (rubber). The saturated skeletal structure leads to classical characteristics, for example a high weathering and moisture resistance and ozone resistance, as well as a high thermal resistance. It is used because of its high resilience and good chemical resistance. EPDM rubber has high tear strength. As a result of being stored in a greatly expanded state (approximately 200% expansion, i.e. three times the diameter), the rubber tube loses approximately 30 to 50% of its original diameter. The tube can also be produced from silicone which has relatively high water permeability and a relatively low tear strength.

With reference to FIG. 23, a barrier layer 18, which is configured as a foil tube, is shown. This barrier layer 18 (i.e. foil tube) is provided separately and drawn over the interior sleeve 10 and/or shielding wire couplings before the external sleeve 10 is installed. The use of this barrier layer 18 (i.e. foil tube) is possible with all types of external sleeve 10.

The barrier layer 18 which is of a reduced fluid permeability, is positioned between the sleeve body 14 and the outer wall 20. This barrier layer 18 can be a single or multi-layer plastics material, or a metal foil which is coated with plastics material.

FIG. 24 shows a thick-walled tube with a thin-walled foil or coating which has been pre-expanded on a spiral hold-out, shown in longitudinal section.

The outer wall 20, together with the barrier layer 18 and the electrical shielding 16, can be configured so that it folds down, as is further illustrated with reference to FIG. 2. In the variant, which can be folded down, the hold-out is half as long as in the variant which cannot be folded down, and the sleeve 10 takes less time to install.

With reference back to FIG. 2, a longitudinal section through the sleeve 10 in which the tubular supporting element 12 can be seen. Arranged around the supporting element 12 is the sleeve body 14 which, in turn, is surrounded by the electrical shielding 16. The barrier layer 18 around the copper gauze is in turn surrounded by the outer wall 20.

Clearly, the electrical shielding 16, the barrier layer 18 and the outer wall 20 are folded back to facilitate the joining of the cable ends. As soon as this junction has been performed, the electrical shielding 16, the barrier layer 18 and the outer wall 20 can be re-folded over the sleeve body 14 to then close the sleeve 10. In the case of the all-in-one sleeve 10, there is no longitudinal seam through which the water vapour could enter.

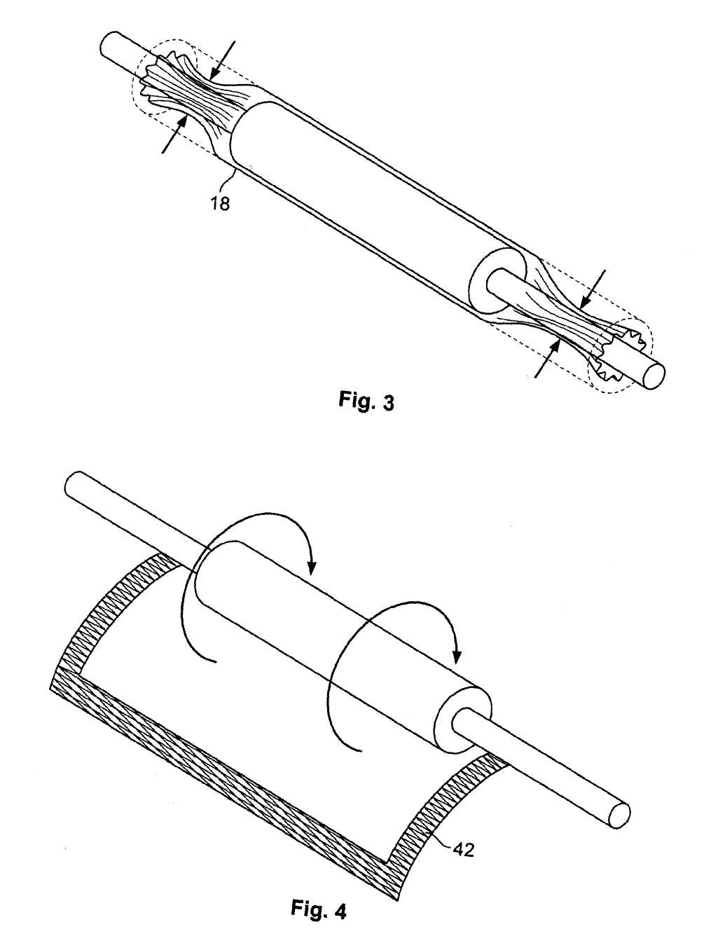

It can be seen in FIG. 3 that the barrier layer 18 can be closed in tubular form at both ends, for example by cable binders, adhesive tape or rubber sealing rings.

FIG. 4 shows an embodiment of the invention in which the barrier layer 18 is not provided in tubular form, but is used for enveloping the sleeve 10. In order to ensure the water tightness, sealing tape or mastic 42 can be provided on the edges.

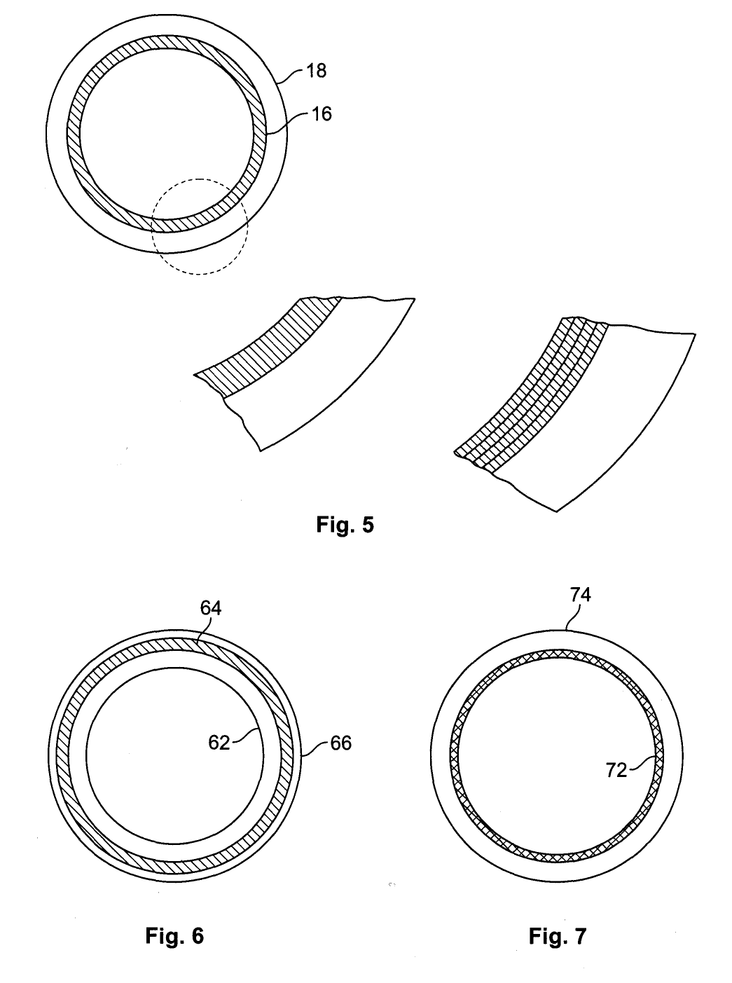

FIG. 5 shows that several embodiments of the electrical shielding 16. In one embodiment shown, the electrical shielding 16 can consist of a layer of, for example copper gauze. However, the electrical shielding 16 can also consist of a metal foil wound round in multiple layers, which increases the flexibility of the sleeve 10, as shown in the other embodiment.

The metallic layers can also be configured to be capable of carrying a current. In this case, a defined minimum cross section is necessary. Since, the deformation behaviour becomes unfavourable in a layer, a thin foil or a copper gauze can be wound in many layers or two of the mentioned tubes can be used one over the other.

As shown in FIG. 6, the barrier layer 62, 66 can be positioned on one or both sides of the electrical shielding 64. This protects the sleeve body 14 and also the outer tube from possibly sharp parts of the electrical shielding 16, which may consist of copper braid. The barrier layer 62, 66 thus acts as a shock absorber and prevents the outer tube from splitting when laid in the ground and when there are sharp stones in the earth.

Instead of having a copper braid as an additional layer in the construction of the sleeve 10, in the embodiment of FIG. 7, the reduced-water-permeability plastics material of the barrier layer 74 is metallised. In FIG. 7, this has been carried out from the inside. This means that the reduced-water-permeability plastics material layer of the barrier layer 74 has an inner coating of metal or metal gauze or has a metal coating on the inside which is located over the sleeve body 14.

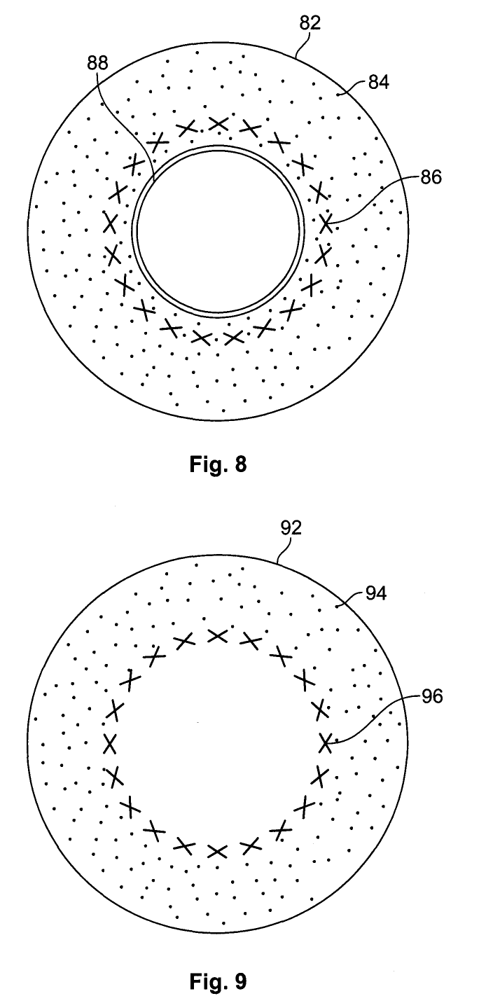

In the embodiment shown in FIG. 8, there are the possibilities of either applying the water-tight plastics material layers of the barrier layer 82 externally around a foamed material 84 or soft elastomer, or applying the water-tight plastics material layers of the barrier layer 88 on the inside. In both cases, embedded into the foamed material 84 is the copper gauze of the electrical shielding 86 which protects outwardly as well as inwardly. This electrical bedding layer reduces a splitting effect of the outer tube and reduces deformations of the sleeve body 14 when there is a relatively great earth pressure.

In FIG. 25, it is shown in longitudinal section that the outer wall 20, such as a thick-walled reduced-permeation tube, can also have an integrated copper gauze. In this case, the tube with integrated copper gauze has already been pre-expanded onto the spiral hold-out.

The use of soft rubber materials, silicone or EPDM, in Shore hardnesses of AS to A30, from A10 to A20 is advantageous over a foaming, as this is compressed under the great radial pressure of the outer tube. A soft rubber cannot be compressed.

FIG. 9 shows another embodiment having the water-tight plastics material layer of the barrier layer 92 on the outside, and therein the foamed material 94 or soft elastomer which, in turn, has the copper gauze of the electrical shielding 96 on the inside. This ensures the metallic contact to the conductive layer of the sleeve body 14.

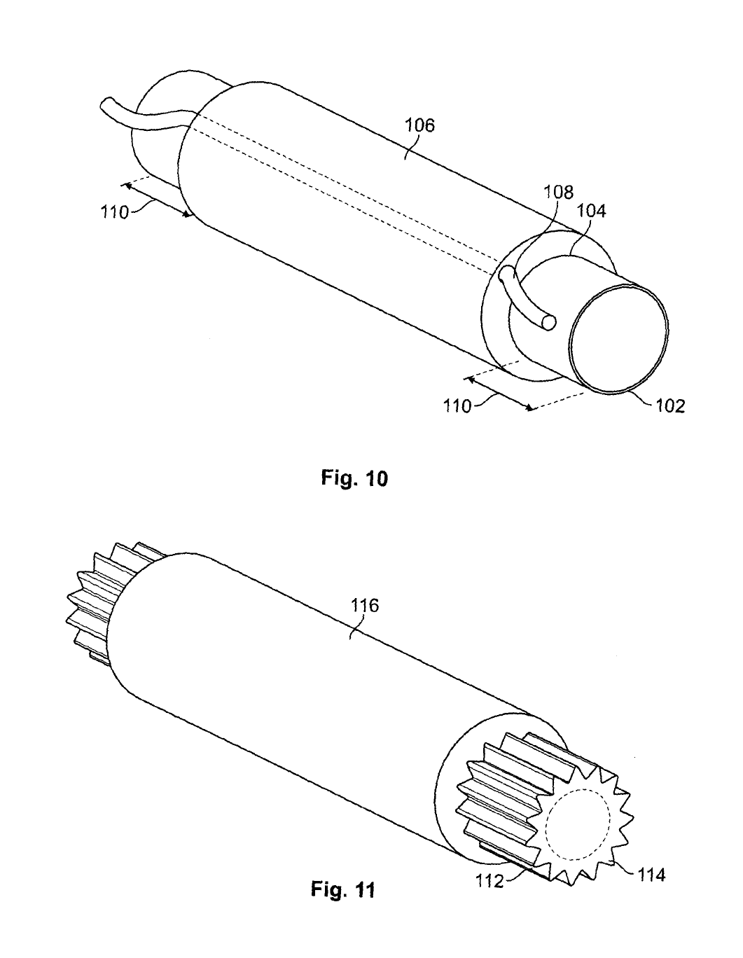

FIG. 10 shows a further embodiment in which there are located at both ends of the external sleeve regions 110 in which the plastics material coating 106 has been removed to ensure an improved electrical contacting. This plastics material coating 106 is optionally thick-walled to be able to act as a cushion or shock absorber. In this case as well, the reduced-water-permeability foil of the barrier layer 104 is applied onto the metallic layer 102. It is also possible for a metallic element 108, for example a copper wire, to be embedded in the thick-walled plastics material coating 106. This metallic element 108 requires a specific cross section in order to transmit electrical currents.

FIG. 11 shows an alternate thick-walled plastics material coating 116, which can act as a cushion or shock absorber. Located on the inside of this plastics material coating 116 is the metallic layer 112, which is configured in this case as an undulating profile. This is advantageous for radial expansion, since it simplifies this or even allows it. As an option, an additional plastics material layer would also be possible on the inside of this metallic layer which is configured in an undulating profile and acts as an additional cushion.

The wall thickness of the bedding and shock absorber layer described above should be from 1 to 8 mm, or from 3 to 4 mm.

All the drawings of the new external sleeve 10 embodiments generally show these as a compilation. A person skilled in the art will recognize that the layers can also be produced separately for the most part and then laid/bonded/welded/partially joined.

The re jacketing can be supplied as a separate element to the customer who then for his part combines this with sleeves optionally produced by other manufacturers. However, the re-jacketing film can also be integrated into the supplied sleeve 10, for example a cold shrink sleeve on hold-out.

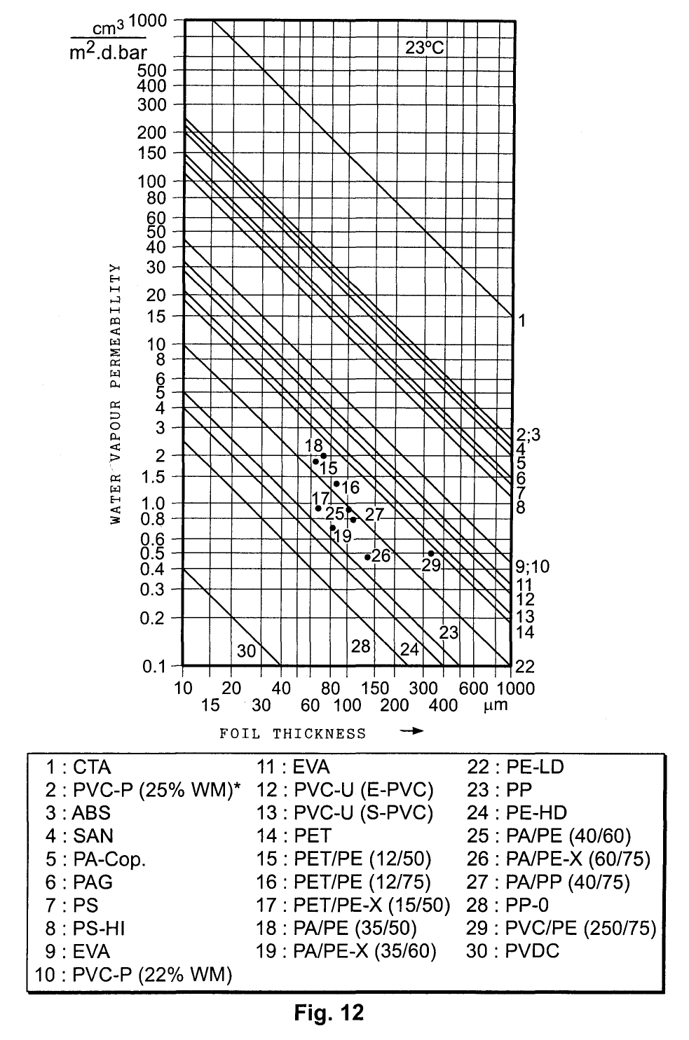

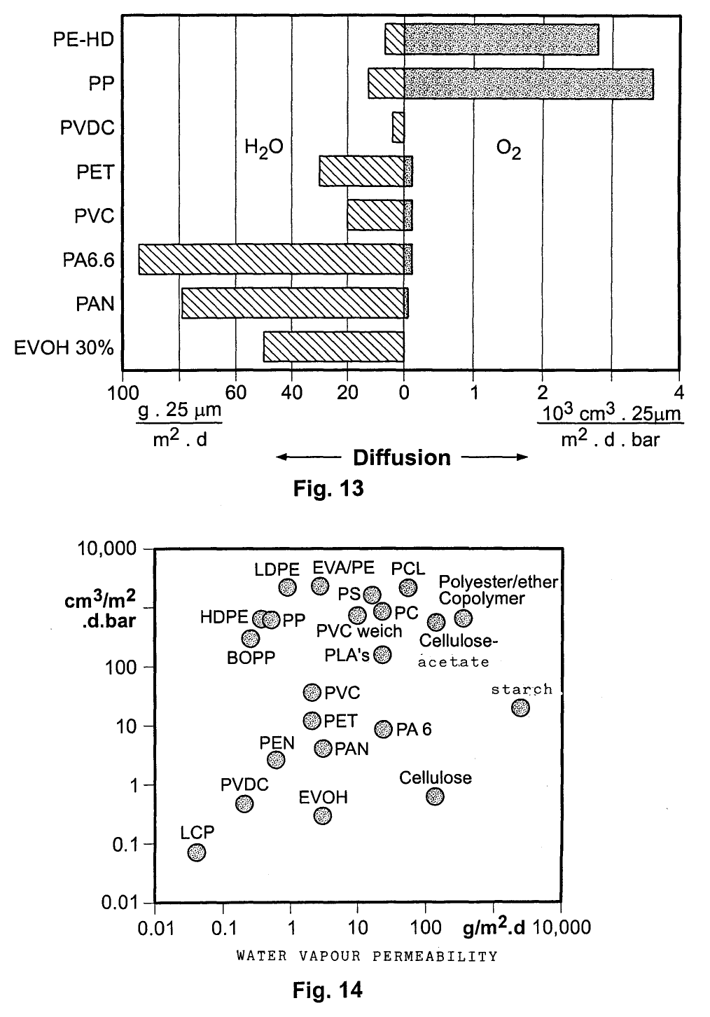

The solutions described above make it possible to reduce the permeation by a factor of at least 10. To illustrate the specific numbers for the water vapour permeability, said water vapour permeability is shown in FIG. 12 against the foil thickness. Further values of the water vapour permeability are provided in FIGS. 13, 14 and 15.

In detail, FIG. 12 shows the water vapour permeability of various materials as a function of the foil thickness at 23° C. It is possible to read from FIG. 12, for example that CTA and PVC-P are more permeable to water vapour than PP-O and PVDC. Thus, FIG. 12 can be consulted in order to select a suitable material for the barrier layer 104.

FIG. 13 shows the oxygen and water vapour barrier values of current plastics materials. The data was determined at 70% relative humidity on 25 μm thick foils under standard conditions. It can be seen from FIG. 13 that, for example PE-HD and PP 6.6 are much more permeable to oxygen than the other mentioned plastics materials and that PA 6.6 and PAN are much more permeable to water vapour than the other plastics materials shown. FIG. 13 can in turn be helpful in selecting suitable plastics materials for the barrier layer 104.

In a somewhat different form of presentation, FIG. 14 shows the oxygen and water vapour permeability of selected polymers. FIG. 14 shows, for example, that rigid PVC is less permeable to water vapour than soft PVC and also allows the passage of less oxygen. Again, this diagram is helpful in selecting suitable materials for the barrier layer 104.

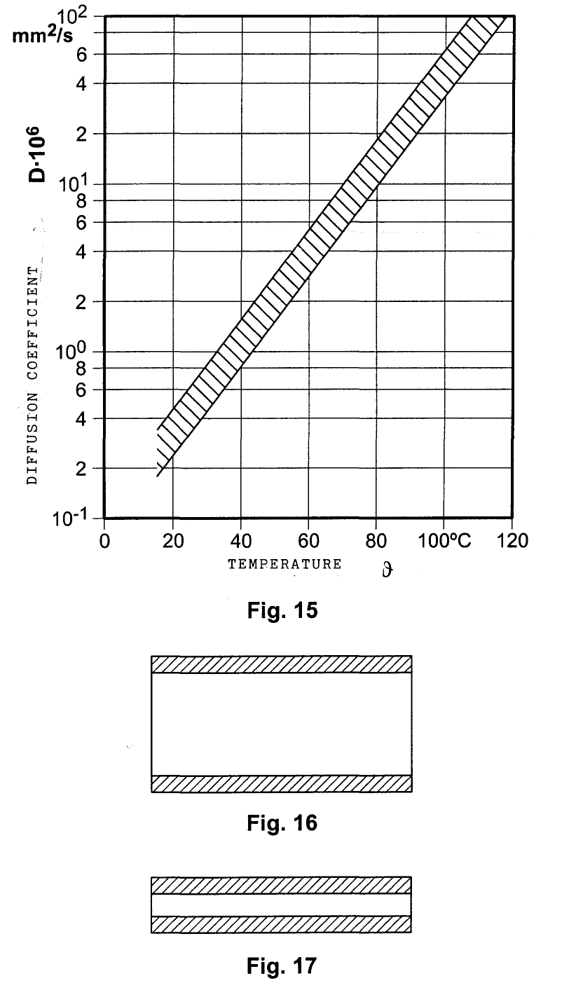

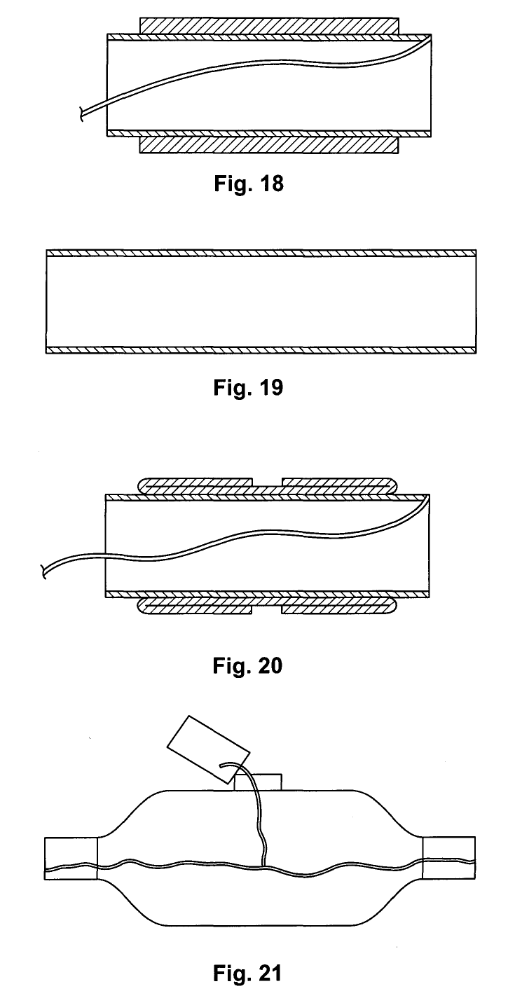

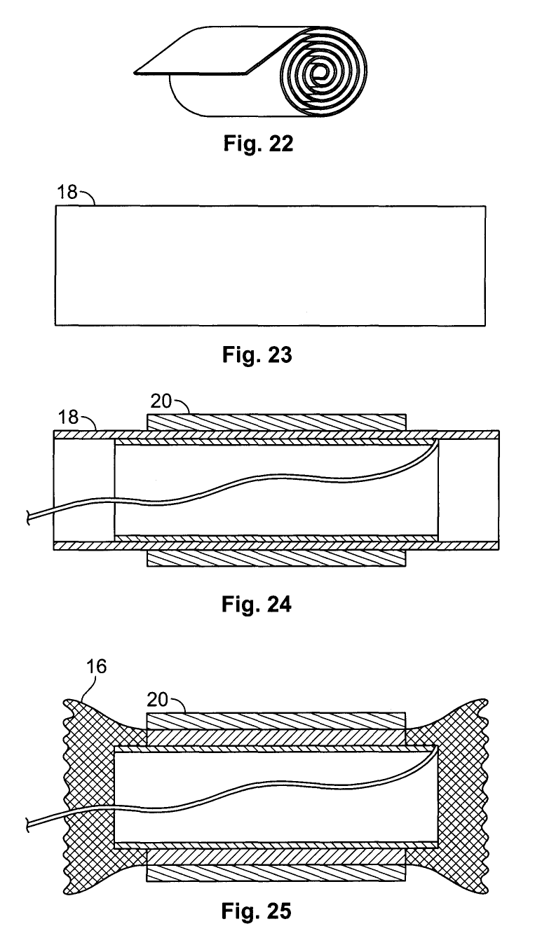

FIG. 15 shows the temperature dependency of the diffusion coefficient for PA 6, 12 and 66 in a logarithmic graph. It can be clearly seen from this Figure that the diffusion coefficient increases exponentially with the temperature. This Figure is helpful in demonstrating the principle of the diffusion coefficient.

The use of the cold shrink method has the advantage that digging in the road does not have to involve a heat source, which entails potential risks, and also fewer tools are needed. In this case, the greatest source of errors is the competence and experience of the installers, whose safety and quality of training must also be considered. The sleeve 10 according to the invention can also advantageously be used in the heat shrink method, which allows more flexibility.

The integration of the shielding layer in the barrier layer 104 has the advantage that the sleeve 10 consists of fewer components, which makes the production and installation simpler and more reliable and leads to a reduction in costs.

If the barrier layer 18 is arranged under the shielding layer, the shielding layer forms a physical protective layer for the sleeve body 14. This is important, for example, if a digger or a spade should strike the external sleeve 10. Moreover, it is advantageous that a cushioning and superficial protection of the sleeve body 14 is then provided with respect to the shielding layer, which is otherwise pushed with great force through the extended outer tube into the surface, which relates above all to the still uninstalled state.

If the barrier layer 18 is applied over the shielding layer, this barrier layer 104 also protects the protective tube against possible sharp edges, kinks and bends in the wires to the shielding layer. Protection against incorrect handling and possible manufacturing faults is also provided hereby.

If the barrier layer 18 consists of metal, possibly with a plastics material coating 106, the minimum cross section of the wires in the shielding layer can be increased, and thus an improved shielding can be achieved. In this case, two of these shielding layers could be used to ensure a greater flexibility. If only one shielding layer were to be used, this would be relatively rigid.

The shielding layer advantageously consists of multilayered plastics material if the metal is omitted, to ensure the flexibility and water tightness of the external sleeve 10.

It is advantageous for the shielding layer to consist of copper gauze, as this expands easily, up to more than 200%, and is flexible.

If the shielding layer consists of at least two metal foils, this has the advantage that the shielding layer is more flexible. This means that cable bends of a relatively small radius are allowed and it is possible to avoid breaks.

The formation of the shielding layer as an undulating profile allows it to expand radially.

The foregoing illustrates some of the possibilities for practicing the invention. Many other embodiments are possible within the scope and spirit of the invention. It is, therefore, intended that the foregoing description be regarded as illustrative rather than limiting, and that the scope of the invention is given by the appended claims together with their full range of equivalents.

What is claimed is:

1. An external sleeve for joining two or more cable ends, comprising:
a sleeve body;
an electrically conducting shielding layer arranged along an outside of the sleeve body;
an outer wall arranged along the outside of the shielding layer; and
a barrier layer having a permeability factor, the barrier layer being arranged along the inside of the outer wall.

2. The external sleeve according to claim 1, further comprising a tubular supporting element positioned along the inside of the sleeve body.

3. The external sleeve according to claim 2, wherein the tubular supporting body includes an opening into which the cable ends are introduced.

4. The external sleeve according to claim 1, wherein the external sleeve is a single-piece assembly.

5. The external sleeve according to claim 1, wherein the external sleeve is applied to a cold shrink tube.

6. The external sleeve according to claim 4, wherein the external sleeve is applied to a cold shrink tube.

7. The external sleeve according to claim 1, wherein the external sleeve is applied to an outer tube by a winding, water shrinkage or slip-on method.

8. The external sleeve according to claim 1, wherein the external sleeve is configured for underground use.

9. The external sleeve according to claim 7, wherein the external sleeve is configured for underground use.

10. The external sleeve according to claim 1, wherein the shielding layer is integrated into the barrier layer.

11. The external sleeve according to claim 1, wherein the barrier layer is positioned radially under or over the shielding layer.

12. The external sleeve according to claim 1, wherein the barrier layer consists of multilayered plastic material.

13. The external sleeve according to claim 1, wherein the barrier layer consists of a metal layer.

14. The external sleeve according to claim 1, wherein the barrier layer has a metal coating.

15. The external sleeve according to claim 14, wherein the metal coating is vapor deposited onto the barrier layer.

16. The external sleeve according to claim 1, wherein the barrier layer includes at least one layer of fluorinated plastic material.

17. The external sleeve according to claim 1, wherein the barrier layer is configured to be wound.

18. The external sleeve according to claim 1, wherein the shielding layer includes copper gauze, full-surface metal foil, or at least one wire.

19. The external sleeve according to claim 1, wherein the shielding layer consist of at least two metal foils.

20. The external sleeve according to claim 1, wherein the shielding layer is formed as an undulating profile.
